(19) United States
(12) Patent Application Publication
(10) Pub. No.: US 2025/0327681 A1
(43) Pub. Date: Oct. 23, 2025

(54) METHOD AND APPARATUS FOR CONTROLLING A VEHICLE

(71) Applicants: Hyundai Motor Company, Seoul (KR); Kia Corporation, Seoul (KR)

(72) Inventors: Chang Woo Chun, Suwon-Si (KR); Hae Young Kwon, Suwon-Si (KR); Song Eun Lee, Seongnam-Si (KR)

(21) Appl. No.: 18/921,648

(22) Filed: Oct. 21, 2024

(30) Foreign Application Priority Data
Apr. 17, 2024 (KR) 10-2024-0051402

(51) Int. Cl. G01C 21/36

(52) U.S. Cl. CPC G01C 21/3629; G01C 21/3608; G01C 21/3679; G01C 21/3691

(57) ABSTRACT

A method for controlling operation of a vehicle is introduced. The method may comprise acquiring, based on a first machine learning model associated with a current input and a previous stream of inputs, a primary response to the current input, acquiring, based on a second machine learning model and a third machine learning model to the primary response, a secondary response, wherein the second machine learning model is tuned to provision of position information and weather information associated with the vehicle, and wherein the third machine learning model is tuned to provision of vehicle information, adjusting, based on a fourth machine learning model, the secondary response, wherein the fourth machine learning model is tuned to a length adjustment of the secondary response or tuned to verification of information associated with the secondary response, outputting the adjusted secondary response, and controlling, based on the adjusted secondary response, operation of the vehicle.

### CROSS-REFERENCE TO RELATED APPLICATION

This application claims priority to Korean Patent Application No. 10-2024-0051402, filed on Apr. 17, 2024 in the Korea Intellectual Property Office, the entire contents of which are incorporated herein by reference.

### TECHNICAL FIELD

Examples of the present disclosure relate to a method and apparatus for providing response to user's voice using language models.

### BACKGROUND

The content described below simply provides background information related to the present example and does not constitute prior art.

With the development of an artificial intelligence scheme, a range of applications thereof is expanding. In particular, a conversation system that enables a conversation with a user using natural language, such as a chatbot or a virtual assistant, is being utilized in various fields. In order for the conversation system to perform the conversation with the user, it is necessary to understand an utterance of the user, that is, an input message, from the perspective of the conversation system. In order to achieve such natural language understanding (NLU), the conversation system derives a current context and an intention of the user expected from the context of the conversation between the conversation system and the user, and analyzes the input message based on the derived context and/or intention.

A range of application of such a voice recognition service is expanding from the home to various fields such as automobiles. Additionally, telematics technology may include various functions. Examples of the functions may include a real-time navigation function, an information search function using the Internet, and a function such as optimization of an in-vehicle environment utilizing a position of a vehicle and weather information.

A combination of a voice recognition service and telematics technology may be based on a concept in which a voice command generated by an utterance of a user is used to perform functions provided by the telematics technology. If the user requests a navigation function or an information search function through a voice command, a vehicle starts a corresponding operation. A combination of these technologies may provide convenience and enjoyment to the user, and for this reason, this field is also called infotainment technology.

Meanwhile, chatbots or virtual assistants that understand and process natural language (Natural Language Processing; NLP) and generate the natural language (Natural Language Generation; NLG) are also attracting attention. The chatbots or virtual assistants improve user experience by responding to a question or a request from a user with natural language.

A language model becomes a basis for natural language generation. In particular, very large AI such as a large language model (LLM) is trained by using a very large amount of text data. This may be utilized for various tasks such as natural language understanding, natural language processing, sentence generation, machine translation, and automatic summarization.

The LLM may be trained based on a dataset consisting of tens of billions of sentences. This dataset may comprise various web documents from the Internet, books, newspaper articles, blogs, or the like, and text data.

LLM may be trained by utilizing all datasets from several domains so that an appropriate response is provided in various domains. However, sometimes, the LLM may be trained by additionally utilizing datasets specialized for a specific field so that a more accurate response may be provided in relation to a specific field. This may be referred to as tuning or adaptation of the LLM. In order to utilize a pre-trained LLM in a specific domain, additional learning may be performed by using datasets collected from the domain.

A navigation system are being developed to provide advanced services based on cutting-edge technologies such as artificial intelligence (AI), voice recognition, and big data. However, in the case of a navigation system, only pre-programmed tasks may be performed according to determined instructions, and functions thereof are limited to destination route guidance or the like.

Therefore, there is a need for technology for a method of using a generative language model (LLM) to enhance user experience, such as not only destination route guidance but also recommendation of nearby attractions.

### SUMMARY

According to the present disclosure, a method for controlling operation of a vehicle, the method comprising acquiring, based on a first machine learning model associated with a current input and a previous stream of inputs, a primary response to the current input, acquiring, based on applications of a second machine learning model and a third machine learning model to the primary response, a secondary response, wherein the second machine learning model is tuned to provision of position information and weather information associated with the vehicle, and wherein the third machine learning model is tuned to provision of vehicle information, adjusting, based on a fourth machine learning model, the secondary response, wherein the fourth machine learning model is tuned to a length adjustment of the secondary response or tuned to verification of information associated with the secondary response, outputting the adjusted secondary response, wherein the current input or the previous stream of inputs is related to a request for information of a destination area or a target area for the vehicle, and controlling, based on the adjusted secondary response, operation of the vehicle.

The method, wherein the acquiring the primary response comprises inputting a first input for semantic inference to the first machine learning model, inputting a second input for function classification to the first machine learning model, inputting a third input for a query creation to the first machine learning model, searching, based on the query generated by the first machine learning model, for a document in a database, and inputting, based on content of the document, a fourth input for generation of the primary response to the first machine learning model.

The method, wherein the acquiring the secondary response comprises acquiring, based on positions of the destination and the target area, an estimated travel time from the destination to the target area, and adding the estimated travel time to the primary response.

The method, wherein the acquiring the secondary response comprises acquiring weather information of the destination and weather information of the target area, and adding the weather information of the destination and the weather information of the target area to the primary response.

The method, wherein the acquiring the secondary response comprises acquiring information on a vehicle type of the vehicle, and adding, based on a place being related to the vehicle type within the destination and the target area, information on the place to the primary response, and adding, based on owners of the same vehicle type having visited the destination and the target area, information on a visit frequency to the primary response.

The method, wherein the adjusting the secondary response comprises comparing a time remaining until another guidance with a length of the secondary response, and decreasing, based on the length of the secondary response exceeding the time remaining until the other guidance, the length of the secondary response.

The method, wherein the adjusting the secondary response comprises increasing or decreasing a length of the secondary response to meet a request from a user of the vehicle, wherein the request is received within the current input and the previous streams of inputs.

The method, wherein the adjusting the secondary response comprises verifying, based on a database used for the primary response and the secondary response, the secondary response, and determining whether a prohibited word is included in the secondary response.

The method, wherein the vehicle information comprises information on a place related to a vehicle type of the vehicle within the destination area and the target area.

The method, wherein the vehicle type comprises at least one of electric vehicle, hybrid vehicle, internal combustion engine vehicle, solar-powered vehicle, or hydrogen fuel cell vehicle.

According to the present disclosure, an apparatus for controlling operation of a vehicle, the apparatus comprising a memory configured to store one or more instructions, and at least one processor configured to execute the one or more instructions to acquire, based on a first machine learning model associated with a current input and a previous stream of inputs, a primary response to the current input, acquire, based on applications of a second machine learning model and a third machine learning model to the primary response, a secondary response, wherein the second machine learning model is tuned to provision of position information and weather information associated with the vehicle, and wherein the third machine learning model is tuned to provision of vehicle information, adjust, based on a fourth machine learning model, the secondary response, wherein the fourth machine learning model is tuned to a length adjustment of the secondary response or tuned to verification of information associated with the secondary response, output the adjusted secondary response, wherein the current input or the previous stream of inputs is related to a request for information of a destination area or a target area for the vehicle, and control, based on the adjusted secondary response, operation of the vehicle.

The apparatus, wherein the at least one processor is further configured to execute the one or more instructions to input a first input for semantic inference to the first machine learning model, input a second input for function classification to the first machine learning model, input a third input for query creation to the first machine learning model, search, based on a query generated by the first machine learning model, for a document in a database, and input, based on content of the document, a fourth input for generation of the primary response to the first machine learning model.

The apparatus, wherein the at least one processor is further configured to execute the one or more instructions to acquire, based on positions of the destination and the target area, an estimated travel time from the destination to the target area, and add the estimated travel time to the primary response.

The apparatus, wherein the at least one processor is further configured to execute the one or more instructions to acquire weather information of the destination and weather information of the target area, and add the weather information of the destination and the weather information of the target area to the primary response.

The apparatus, wherein the at least one processor is further configured to execute the one or more instructions to acquire information on a vehicle type of the vehicle, and add, based on a place being related to the vehicle type within the destination and the target area, information on the place to the primary response, and add, based on owners of a same vehicle type having visited the destination and the target area, information on a visit frequency to the primary response.

The apparatus, wherein the at least one processor is further configured to execute the one or more instructions to compare a time remaining until another guidance with a length of the secondary response, and decrease, based on the length of the secondary response exceeding the time remaining until the other guidance, the length of the secondary response.

The apparatus, wherein the at least one processor is further configured to execute the one or more instructions to increase or decrease a length of the secondary response to satisfy a request from a user of the vehicle, wherein the request is received within the current input and the previous stream of inputs.

The apparatus, wherein the at least one processor is further configured to execute the one or more instructions to verify, based on a database used for the primary response and the secondary response, the secondary response, and determine whether a prohibited word is included in the secondary response.

The apparatus, wherein the vehicle information comprises information on a place related to a vehicle type of the vehicle within the destination area and the target area.

The apparatus, wherein the vehicle type comprises at least one of electric vehicle, hybrid vehicle, internal combustion engine vehicle, solar-powered vehicle, or hydrogen fuel cell vehicle.

### BRIEF DESCRIPTION OF THE DRAWINGS

FIG. 1 shows an example of a response system according to an example of the present disclosure.

FIG. 2 shows an example of a current utterance and a previous conversation according to an example of the present disclosure.

FIG. 3 shows an example of a method of generating a primary response of a first language model according to an example of the present disclosure.

FIG. 4 shows an example of an overall flow of a method of providing a response according to an example of the present disclosure.

FIG. 5 shows an example computing device that may be used to implement the method or device according to examples of the present disclosure.

### DETAILED DESCRIPTION

Hereinafter, some examples of the present disclosure will be described in detail with reference to the accompanying drawings. In the following description, like reference numerals preferably designate like elements, although the elements are shown in different drawings. Further, in the following description of some examples, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe examples of the present disclosure, and is not intended to represent the only examples in which the present disclosure may be practiced.

In the present disclosure, ‘tuning’ may refer to a process of adjusting a configuration, parameters, or the like of a deep learning model for further improved performance or for a new purpose based on a previously learned deep learning model. For example, the tuning may include updating weights, parameters, or the like of some layers included in a deep learning model using additional learning data.

Meanwhile, in the present disclosure, ‘adjusting’ a second response includes reviewing or modifying a secondary response using a tuned language model. Therefore, this may be distinguished from ‘adjusting’ in a process of adjusting a configuration, parameters, or the like of a deep learning model, or the like in that an object of ‘adjusting’ is different from that of ‘adjusting’ in a process of adjusting a configuration or parameters of a deep learning model, or the like.

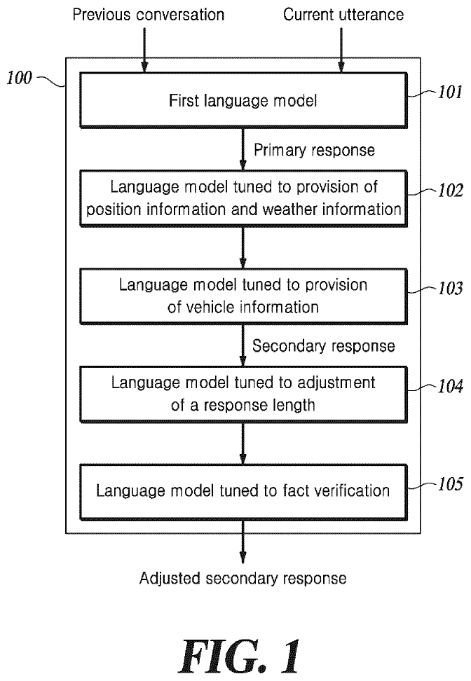

FIG. 1 shows an example of a response system according to an example of the present disclosure.

Referring to FIG. 1, a response system 100 provides a response that meets a question or request provided by voice by a user. The response system 100 may be implemented using a computing device 50. The computing device 50 may be embedded in a vehicle. According to one embodiment of the present disclosure, the process of providing a response to a user's voice using a response system embedded in the vehicle may be implemented by controlling the vehicle. The response system 100 may convert the adjusted secondary response into a format that may be provided as an AVNT (Audio, Video, Navigation, Telecommunication) scenario to provide a response. For example, if a user asks a question, “Please explain Jindo Bridge,” an adjusted secondary response thereto is, “Jindo Bridge is the only land route that connects Haenam to Jindo, Jeollanam-do. Jindo Bridge has a width of 11.7 m and a length of 484 m, is Korea's first cable-stayed bridge which began construction in December of 1980 and was completed in October of 1984, and has an A-shaped bridge tower and a radial cable layout. This is a tourist destination famous for its formative beauty and the beauty of its surroundings.” The response system 100 may not only output the response as TTS (Text-to-Speech), but also display a phrase ‘Jindo Bridge Guide’ through a display.

The response system 100 includes machine learning models such as a first language model 101, a language model 102 tuned to provision of position information and weather information, a language model 103 tuned to provision of vehicle information, a language model 104 tuned to adjustment of a response length, and a language model 105 tuned to fact verification.

The first language model 101 generates a primary response based on a current input (e.g., utterance) and a previous streams of inputs and/or outputs (e.g., a previous conversation).

The current utterance and the previous conversation are collectively referred to as an entire conversation.

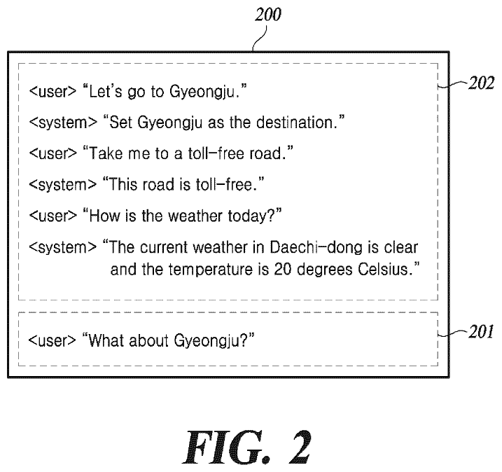

Referring to FIG. 2, an entire conversation 200 exchanged between the user and the response system includes a current utterance 201 and a previous conversation 202.

The current utterance 201 refers to the most recent word or sentence that the user provides to the response system. The utterance generally refers to speech, but may also include text or images (e.g., icons, emojis, etc.) in some cases. The current utterance includes a question or a request from the user.

The previous conversation 202 is a conversation other than the current utterance 201 in the entire conversation 200. The first language model may increase the accuracy of the response by generating the primary response by considering not only the current utterance 201 but also the previous conversation 202.

The current utterance 201 refers only to a word or a sentence that the user provides to the response system, whereas the previous conversation 202 includes the response that the response system provides to the user. The current utterance may be relevant to a request for information on the destination or information on the target area.

The target area is a place that the user may visit on the way to the destination or after arriving at the destination, and includes local attractions or tourist attractions that may be recommended to the user. The target area may be understood as a broader concept than a destination or transit point, commonly referred to as points of interest (POI).

The language model 102 tuned to provision of position information (e.g., GPS coordinates, speed, altitude, direction/heading, lane position, proximity to other vehicles, distance traveled, current road or street name, intersection proximity, elevation (e.g., uphill, downhill), location within a map grid, geofencing status, turning angle, relative position to landmarks, parking position, latitude and longitude, vehicle's centerline position, angle of inclination (tilt), cross-track error (deviation from a planned path), or time-to-destination, etc.) and weather information (e.g., sunny, cloudy, partly cloudy, overcast, rainy, showers, thunderstorm, snowy, sleet, hail, windy, foggy, misty, humid, hot, cold, freezing rain, blizzard, tornado, or hurricane, etc.) generates the response based on the position or the weather and adds the response to the primary response to generate a secondary response.

The response based on the position information may provide an estimated travel time from the destination to the target area. To provide the estimated travel time, the language model 102 may perform an operation for collecting the position information of the destination and the target area and calculating the estimated travel time from the destination to the target area.

The response based on the weather information may provide weather information of the destination and the target area. To provide the weather information, the language model 102 may preemptively collect the position information of the destination and the target area.

To generate the response based on the position information or weather information, the same language model tuned to be suitable for provision of both types of information, for example, the position information and the weather information, may be used.

The language model 103 tuned to provision of vehicle information generates a response based on the vehicle information and adds this response to the primary response, thereby generating a secondary response.

The response based on the vehicle information may provide information on a place related to a vehicle type (e.g., Electric Vehicle (EV), Hybrid Vehicle (HEV), Plug-in Hybrid Vehicle (PHEV), Internal Combustion Engine Vehicle (ICEV), Hydrogen Fuel Cell Vehicle (FCV), Battery Electric Vehicle (BEV), Mild Hybrid Vehicle (MIHEV), Flex-Fuel Vehicle (FFV), Compressed Natural Gas Vehicle (CNG), Extended Range Electric Vehicle (EREV), and Solar-Powered Vehicle, etc.). Information on the place related to the vehicle type may be i) information on a place if there is the place related to the vehicle type within the destination or target area, and ii) information on a visit proportion if owners of the same vehicle type have visited the destination or target area.

An example of i) may be that the vehicle type is an electric vehicle. If the vehicle type is the electric vehicle, a response based on the vehicle information may be providing information on electric vehicle charging stations within the destination or target area.

In order to provide the information on the electric vehicle charging stations, the language model 103 may perform an operation of collecting position information of the destination and the target area and search to determine whether there is an electric vehicle charging station within the destination and target area through the Internet.

An example of ii) may be a case where there is a database in which a large amount of position information of a place visited by vehicles of the same type is collected. This database may be managed by a specific entity and may be provided by the specific entity, or the database may be not managed by the specific entity and may be obtained by searching for information published on the Internet. If there is the database, the response based on the vehicle information may provide information on how many vehicle owners of the same type of vehicle have visited the destination or the target area, for example a visit proportion or frequency, represented in percentage.

In order to provide the information on how many vehicle owners of the same type of vehicle have visited the destination or target area, the language model 103 collects the vehicle information of the user to ascertain a vehicle type, searches for the number of vehicle owners of the same type of vehicle, and collects the position information of the destination and the target area. The language model 103 may perform searching for the number of vehicle owners who have visited the destination and the target area among all owners of the same type of vehicle and dividing the number by a total number of owners of the same type of vehicle to calculate the visit proportion.

The language model 104 tuned to adjustment of the response length i) compares the time remaining until another guidance with the length of the secondary response, and decreases the length of the secondary response if the length of the secondary response exceeds the time remaining until another guidance, and ii) determines whether there is a user request regarding the length of the secondary response in the current utterance and the previous conversation, and increases or decreases the length of the secondary response if there is the user request, to adjust the secondary response.

Regarding i), the other guidance refers to a route guidance, or the like generally provided by a navigation system of the related art so that the user may go from the current position to the destination or target area. The route guidance may include guidance on the appearance of a toll gate 300 m ahead and guidance on an entrance/exit route for highway changing.

Regarding i), the length of the secondary response refers to a length of time it takes for the secondary response to be provided to the user if the response system 100 according to an example of the present disclosure outputs the secondary response as is without adjusting the secondary response.

For example, assuming that the secondary response generated by the language model 102 tuned to provision of position information and weather information or the language model 103 tuned to provision of vehicle information is output in a Text-to-Speech (TTS) format, a length of time it takes for the response system 100 according to the example of the present disclosure to transfer the secondary response by voice becomes the length of the secondary response. The TTS is a technology that converts written text into spoken words. The TTS format refers to the data or text input that is processed by a TTS engine to generate audible speech. A length of time it takes for the response system 100 to output a voice from a first phoneme to a last phoneme of the secondary response is the length of the secondary response.

In general, the response based on the position information, the response based on the weather information, and the response based on the vehicle information are for providing the user with additional information related to the destination or target area, and is less important than route guidance used for the user to reach the destination or target area in many cases. Accordingly, the language model 104 tuned to adjustment of the response length adjusts the length of the secondary response so that the secondary response is output only until the other guidance is provided, thereby preventing the secondary response from interfering with route guidance, or the like.

In order to prevent the secondary response from interfering with the route guidance, the language model 104 may compare the time remaining until another guidance with the length of the secondary response, and decreasing the length of the secondary response if the length of the secondary response exceeds the time remaining until another guidance.

The language model 105 tuned for fact verification verifies the secondary response based on the database used for the primary and secondary responses, determines whether a prohibited word is included in the secondary response, and adjusts the secondary response based on a result of the determination.

A process of verifying the secondary response based on the database used for the primary and secondary responses is performed so that the response finally generated by the response system 100 is provided based on the fact.

A process of determining whether a prohibited word is included in the secondary response is performed so that the response finally generated by the response system 100 does not contain content that may cause uncomfortable feelings in the user.

The prohibited words are words or sentences that may be socially problematic and may include expressions of bias or hate. In the response system 100 according to an example of the present disclosure, a list of prohibited words (e.g., profane words) is created and the content of the secondary response is reviewed using the prohibited word list.

If a prohibited word is included in the secondary response, the language model 105 adjusts the secondary response by excluding the prohibited word or replacing the prohibited word with another word.

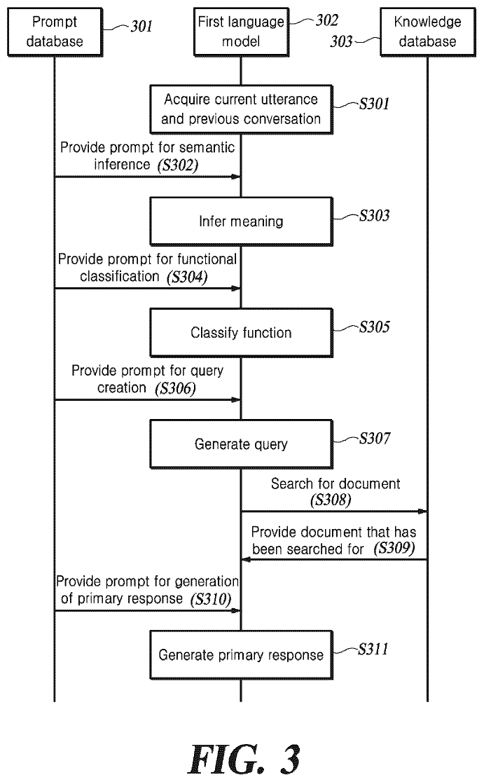

FIG. 3 shows an example of a method of generating a primary response of the first language model according to the example of the present disclosure. For convenience, FIG. 3 is described by way of an example in which the steps are performed by a processor. One, some, or all steps of the example method of FIG. 3, or portions thereof, may be performed by one or more other processors. One or some, steps of the example method of FIG. 3 may be omitted, performed in other orders, and/or otherwise modified, and/or one or more additional steps may be added.

Referring to FIG. 3, the first language model 302 receives prompts or documents from a prompt database 301 and/or a knowledge database 303, and performs four steps including semantic inference (S303), function classification (S305), and query generation (S307), and primary response generation (S311) to generate the primary response.

If the user's utterance is made, the first language model 302 receives the current utterance and previous conversation of the user (S301).

The prompt database 301 provides a prompt for semantic inference (S302). The prompt for semantic inference may be at least one sentence. The one sentence may be, for example, “What do you think is the meaning of the current utterance based on the previous conversation?”

The first language model 302 infers meanings of the current utterance and previous conversation by outputting a response to the input prompt (S303).

The prompt database 301 provides a prompt for functional classification (S304). The prompt for functional classification may be at least one sentence. The one sentence may be, for example, “What function should be executed to answer a meaning of the current utterance?” The prompt for functional classification may include few-shot based examples.

The first language model 302 classifies functions by outputting the response to the input prompt (S305).

The prompt database 301 provides a prompt for query creation (S306). The prompt for query creation may be at least one sentence. The one sentence may be, for example, “Generate a search query for <feature>.” The prompt for query creation may include a name of a database for each function and a full-shot example of a query generation method.

The first language model 302 generates a query by outputting a response to the input prompt (S307).

The first language model 302 utilizes the generated query to search the knowledge database 303 for a document (S308).

The knowledge database 303 provides the document that has been searched for to the first language model 302 (S309).

The prompt database 301 provides a prompt for primary response generation (S310). The prompt for primary response generation may be at least one sentence. The one sentence could be, for example, “<document>, <utterance>, find a response to the utterance in the document.”

The first language model 302 generates a primary response by outputting a response to the input prompt (S311).

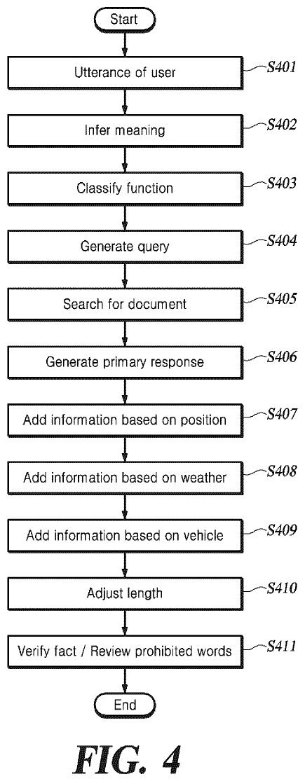

FIG. 4 shows an example of an overall flow of a method of providing a response according to an example of the present disclosure. For convenience, FIG. 4 is described by way of an example in which the steps are performed by a processor. One, some, or all steps of the example method of FIG. 4, or portions thereof, may be performed by one or more other processors. One or some, steps of the example method of FIG. 4 may be omitted, performed in other orders, and/or otherwise modified, and/or one or more additional steps may be added.

If the user's utterance is made (S401), the first language model obtains the current utterance and previous conversation of the user. To input the current utterance and the previous conversation to the first language model, a natural language understanding (NLU) module or a natural language processing (NLP) module may be used.

The first language model infers a meaning (S402), classifies functions (S403), generates queries (S404), searches for documents (S405), and generates a secondary response (S406) based on the current utterance and the previous conversation of the user. A flow is basically the same as that in FIG. 3.

The prompt database and the knowledge database may be used in each of the steps (S402 to S406).

Each of the steps (S402 to S406) may be performed by the first language model generating a response based on the input prompt.

The language model tuned to provision of position information and weather information adds the response based on the position information to the generated primary response (S407) and further adds the response based on the weather information to the generated primary response (S408).

The response based on the position information may be providing an estimated travel time from the destination to the target area. To provide the estimated travel time, the language model 102 may collect the position information of the destination and the target area and calculate the estimated travel time from the destination to the target area.

The response based on the weather information may be providing weather information of the destination and the target area. To provide the weather information, the position information of the destination and the target area may be collected preemptively.

The language model tuned to provision of vehicle information adds the response based on the vehicle information (S409).

The response based on the vehicle information may be providing information on a place related to the vehicle type. The information on the place related to the vehicle type may be i) information on a place if there is the place related to the vehicle type within the destination or target area, and ii) information on a visit proportion if owners of the same type of vehicle have visited the destination or target area.

The response based on the position information, the weather information, and the vehicle information is added so that the secondary response is created.

The language model tuned to adjustment of the response length adjusts the length of the secondary response (S410).

The adjustment of the length of the secondary response may be i) comparing the time remaining until another guidance with the length of the secondary response, and decreasing the length of the secondary response if the length of the secondary response exceeds the time remaining until another guidance; and ii) determining whether there is a user request regarding the length of the secondary response in the current utterance and the previous conversation, and increasing or decreasing the length of the secondary response if there is the user request.

The language model tuned for fact verification verifies whether the secondary response is based on a fact and reviews whether the secondary response includes a prohibited word (S411).

The fact verification may be confirming whether the content of the secondary response has been created based on the database used for the primary response and the secondary response.

Reviewing prohibited words may be confirming whether there is a word in the content of the secondary response included in the list of prohibited words created in advance by the response system.

The secondary response is adjusted by increasing/decreasing a length of the generated secondary response, verifying the facts, and reviewing whether a prohibited word is included.

The response system provides the adjusted secondary response to the user.

Table 1 shows an example of response according to an example of the present disclosure.

TABLE 1

| Date and time | User utterance | System response |
|---|---|---|
| Oct. 30, 2023 | (a) “Let's go to | (b) “Set Haevitch Hotel as the |
| at 10:00 AM | Haevichi Hotel” | destination” |
| Oct. 30, 2023 | (c) “What's around | (d) “There are various things to |
| at 10:05 AM | Haevichi Hotel?” | eat and see around Haevichi |
| | | Hotel & Resort, located in |
| | | Pyoseon-myeon, Seogwipo-si. |
| | | What kind of recommendation |
| | | do you want?” |
| Oct. 30, 2023 | (e) “Tell me about | (f) “There are Jeju Folk |
| at 10:06 AM | tourist attractions” | Village, Seopjikoji, Aqua |
| | | Planet Jeju, Jeju Herb Garden, |
| | | World Liqueur Museum, and |
| | | Pyoseon Beach around |
| | | Haevichi Hotel & Resort.” |
| | | (g) “There is Jeju Folk Village |
| | | within walking distance |
| | | around Haevichi Hotel & |
| | | Resort, and there are |
| | | Seopjikoji and Jeju Herb |
| | | Garden within 15 minutes by |
| | | car. Aqua Planet Jeju is also a |
| | | popular place to visit with |
| | | children. Pyoseon Beach is a |
| | | popular place to visit in the |
| | | summer, but is not |
| | | recommended because the |
| | | weather is very windy and |
| | | chilly today.” |

Referring to Table 1, the current utterance is “Tell me about tourist attractions.” (e) of Table 1 shows this. The previous conversation is the utterance of the user and a system response thereto at Oct. 30, 2023 at 10:00 AMV and Oct. 30, 2023 at 10:05 AMV. (a) to (d) of Table 1 show this.

If the current utterance of the user is made, the first language model receives the current utterance and the previous conversation. In the case of Table 1, if (e) of Table 1 is performed, the first language model receives (a) to (e) of Table 1 as inputs.

The first language model infers a meaning of the current utterance, classifies functions, creates a query for document search, searches for documents, and generates a primary response to the current utterance based on the current utterance and the previous conversation. For generation of the primary responses, the prompt database and the knowledge database may be used. A method by which the first language model generates the primary response has been described in detail in FIG. 3 and FIG. 4.

Referring to Table 1, the primary response is “There are Jeju Folk Village, Seopjikoji, Aqua Planet Jeju, Jeju Herb Garden, World Liqueur Museum, and Pyoseon Beach around Haevichi Hotel & Resort.” (f) of Table 1 shows this. In the case of Table 1, the destination is Haevichi Hotel & Resort, and the target areas are Jeju Folk Village, Seopjikoji, Aqua Planet Jeju, Jeju Herb Garden, World Liqueur Museum, and Pyoseon Beach.

The language model tuned to provision of position information and weather information may add the response based on the position information and the response based on the weather information to the primary response.

The response based on the position information may be the estimated travel time from the destination to the target area(s). In the case of Table 1, the response is the estimated travel time from Haevichi Hotel & Resort to each of Jeju Folk Village, Seopjikoji, Aqua Planet Jeju, Jeju Herb Garden, World Liqueur Museum, and Pyoseon Beach.

The response based on the weather information may be weather at the destination and/or target area. In the case of Table 1, the response is weather at Haevichi Hotel & Resort, Jeju Folk Village, Seopjikoji, Aqua Planet Jeju, Jeju Herb Garden, World Liqueur Museum, and Pyoseon Beach.

Referring to Table 1, the secondary response is “There is Jeju Folk Village within a walking distance around Haevichi Hotel & Resort, and there are Seopjikoji and Jeju Herb Garden within 15 minutes by car. Aqua Planet Jeju is also a popular place to visit with children. Pyoseon Beach is a popular place to visit in the summer, but is not recommended because the weather is very windy and chilly today.” (g) of Table 1 shows this.

When comparing the secondary response to the primary response, i) the response based on the position information, such as “walking distance” and “15 minutes by car”, and ii) the response based on the weather information, such as “not recommended because the weather is very windy and chilly today”, were added.

The response system adjusts the secondary response using the language model tuned to adjustment of response length or fact verification. In the case of Table 1, the adjusted secondary response is the same as the existing secondary response.

The response system outputs the adjusted secondary response. (g) of Table 1 is provided to the user. Additionally, (g) of Table 1 may be converted into a format that may be provided as an AVNT (Audio, Video, Navigation, Telecommunication) scenario.

Table 2 shows an example of response according to an example of the present disclosure.

TABLE 2

| Date and time | User utterance | System response |
|---|---|---|
| Oct. 30, 2023 | (a) “Let's go to | (b) “Set Haevitch Hotel as the |
| at 10:00 AM | Haevichi Hotel” | destination” |
| Oct. 30, 2023 | (c) “What's around | (d) “There are various things to |
| at 10:05 AM | Haevichi Hotel?” | eat and see around Haevichi |
| | | Hotel & Resort, located in |
| | | Pyoseon-myeon, Seogwipo-si. |
| | | What kind of recommendation |
| | | do you want?” |
| Oct. 30, 2023 | (e) “Tell me about | (f) “There is Jeju Folk Village |
| at 10:06 AM | tourist attractions” | within walking distance |
| | | around Haevichi Hotel & |
| | | Resort, and there are |
| | | Seopjikoji and Jeju Herb |
| | | Garden within 15 minutes by |
| | | car. Aqua Planet Jeju is also a |
| | | popular place to visit with |
| | | children. Pyoseon Beach is a |
| | | popular place to visit in the |
| | | summer, but is not |
| | | recommended because the |
| | | weather is very windy and |
| | | chilly today.” |
| Oct. 30, 2023 | (g) “How about | (h) “This is an aquarium |
| at 10:10 AM | Aqua Planet?” | operated by Hanhwa Group, is |
| | | the only aquarium in Jeju, and |
| | | is the largest aquarium in |
| | | Korea.” |
| | | (i) “This is an aquarium |
| | | operated by Hanhwa Group, is |
| | | the only aquarium in Jeju, and |
| | | is the largest aquarium in |
| | | Korea. Among Genesis |
| | | customers who visited Jeju |
| | | Island, 18.4% visited this |
| | | place.” |

Referring to Table 2, the current utterance is “How about Aqua Planet?” (g) of Table 2 shows this. The previous conversation is the utterance of the user and a system response thereto at Oct. 30, 2023 at 10:00 AM, Oct. 30, 2023 at 10:05 AM, and Oct. 30, 2023 at 10:06 AM. (a) to (f) of Table 2 show this.

If the current utterance of the user is made, the first language model receives the current utterance and the previous conversation. In the case of Table 2, if (g) of Table 2 is performed, the first language model receives (a) to (f) of Table 2 as inputs.

The first language model infers a meaning of the current utterance, classifies functions, creates a query for document search, searches for documents, and generates a primary response to the current utterance based on the current utterance and the previous conversation. For generation of the primary responses, a prompt database and a knowledge database may be used. A method by which the first language model generates the primary response has been described in detail in FIG. 3 and FIG. 4.

Referring to Table 2, the primary response is “This is an aquarium operated by Hanhwa Group, is the only aquarium in Jeju, and is the largest aquarium in Korea.” (h) of Table 2 shows this. In the case of Table 2, the destination is Haevichi Hotel & Resort, the target areas are Jeju Folk Village, Seopjikoji, Aqua Planet Jeju, Jeju Herb Garden, World Liqueur Museum, and Pyoseon Beach.

The language model tuned to provision of vehicle information may add the response based on the vehicle information to the primary response.

The response based on the vehicle information may be the information on a visit proportion if owners of the same type of vehicle have visited the destination or target area. In the case of Table 2, since customers of Genesis, that is, the same vehicle brand, have visited Aqua Planet Jeju, which is the target area, the response based on the vehicle information is a proportion of the Genesis customers who visited Aqua Planet Jeju among all the Genesis customers who visited Jeju Island.

Referring to Table 2, the secondary response is “This is an aquarium operated by Hanhwa Group, is the only aquarium in Jeju, and is the largest aquarium in Korea. Among Genesis customers who visited Jeju Island, 18.4% visited this place.” (i) of Table 2 shows this.

When comparing the secondary response to the primary response, the response based on the vehicle information, for example, “Among Genesis customers who visited Jeju Island, 18.4% visited this place.” was added.

The response system adjusts the secondary response using the language model tuned to adjustment of response length or fact verification. In the case of Table 2, the adjusted secondary response is the same as the existing secondary response.

The response system outputs the adjusted secondary response. (i) in Table 2 is provided to the user. Additionally, (i) in Table 2 may be converted into a format that may be provided as an AVNT (Audio, Video, Navigation, Telecommunication) scenario.

Table 3 shows an example of response according to an example of the present disclosure.

TABLE 3

| Date and time | User utterance | System response |
|---|---|---|
| Oct. 30, 2023 | (a) “Let's go to | (b) “Set Haevitch Hotel as the |
| at 10:00 AM | Haevichi Hotel” | destination” |
| Oct. 30, 2023 | (c) “What's around | (d) “There are various things to |
| at 10:05 AM | Haevichi Hotel?” | eat and see around Haevichi |
| | | Hotel & Resort, located in |
| | | Pyoseon-myeon, Seogwipo-si. |
| | | What kind of recommendation |
| | | do you want?” |
| Oct. 30, 2023 | (e) “Tell me about | (f) “There is Jeju Folk Village |
| at 10:06 AM | tourist attractions” | within walking distance |
| | | around Haevichi Hotel & |
| | | Resort, and there are |
| | | Seopjikoji and Jeju Herb |
| | | Garden within 15 minutes by |
| | | car. Aqua Planet Jeju is also a |
| | | popular place to visit with |
| | | children. Pyoseon Beach is a |
| | | popular place to visit in the |
| | | summer, but is not |
| | | recommended because the |
| | | weather is very windy and |
| | | chilly today.” |
| Oct. 30, 2023 | (g) “How about | (h) “This is an aquarium |
| at 10:10 AM | Aqua Planet?” | operated by Hanhwa Group, is |
| | | the only aquarium in Jeju, and |
| | | is the largest aquarium in |
| | | Korea.” |
| Oct. 30, 2023 | (i) “Select this place | (j) “I will start guiding you to |
| at 10:13 AM | as the destination.” | Aqua Planet Jeju. Can I tell you |
| | | more about Aqua Planet Jeju?” |
| Oct. 30, 2023 | (k) “Uh-Huh.” | (l) “Aqua Planet Jeju is an |
| at 10:15 AM | | aquarium operated by Hanhwa |
| | | Group located at 95 Seopjikoji- |
| | | ro, Seongsan-eup, Seogwipo- |
| | | si, Jeju-do. This is the only |
| | | aquarium in Jeju, and is the |
| | | largest in Korea, and is 11 |
| | | times larger than the Aqua |
| | | Planet located at 63 Building, |
| | | Seoul. The aquarium has |
| | | 48,000 animals belonging to |
| | | 500 different species. The |
| | | aquarium positions itself as |
| | | ‘amusement theme park’ for |
| | | education, culture, and |
| | | entertainment.” |
| | | (m) “Aqua Planet Jeju is an |
| | | aquarium operated by Hanhwa |
| | | Group located at 95 Seopjikoji- |
| | | ro, Seongsan-eup, Seogwipo- |
| | | si, Jeju-do. This is the only |
| | | aquarium in Jeju, and is the |
| | | largest in Korea, and is 11 |
| | | times larger than the Aqua |
| | | Planet located at 63 Building, |
| | | Seoul.” <Break for route |
| | | guidance> “The aquarium has |
| | | 48,000 animals belonging to |
| | | 500 different species. The |
| | | aquarium positions itself as |
| | | ‘amusement theme park’ for |
| | | education, culture, and |
| | | entertainment.” |

Referring to Table 3, the current utterance is “Uh-huh.” (k) of Table 3 shows this. The previous conversation is the utterance of the user and a system response thereto at Oct. 30, 2023 at 10:00 AM, Oct. 30, 2023 at 10:05 AM, Oct. 30, 2023 at 10:06 AM, Oct. 30, 2023 at 10:10 AM and Oct. 30, 2023 at 10:13 AM. (a) to (j) of Table 3 show this.

If the current utterance of the user is made, the first language model receives the current utterance and the previous conversation. In the case of Table 3, if (k) of Table 3 is performed, the first language model receives (a) to 0I) of Table 3 as inputs.

The first language model infers a meaning of the current utterance, classifies functions, creates a query for document search, searches for documents, and generates a primary response to the current utterance based on the current utterance and the previous conversation. For generation of the primary responses, the prompt database and the knowledge database may be used. A method by which the first language model generates the primary response has been described in detail in FIG. 3 and FIG. 4.

Referring to Table 3, the primary response is “Aqua Planet Jeju is an aquarium operated by Hanhwa Group located at 95 Seopjikoji-ro, Seongsan-eup, Seogwipo-si, Jeju-do. This is the only aquarium in Jeju, and is the largest in Korea, and is 11 times larger than the Aqua Planet located at 63 Building, Seoul. The aquarium has 48,000 animals belonging to 500 different species. The aquarium positions itself as ‘amusement theme park’ for education, culture, and entertainment.” (l) of Table 3 shows this. In the case of Table 3, the destination is Aqua Planet Jeju. In the case of Table 1 and Table 2, the destination was Haevichi Hotel & Resort, but the destination was changed to Aqua Planet Jeju according to the utterance of the user at Oct. 30, 2023 at 10:13 AM during the previous conversation, “Select this place as the destination.” (i) of Table 3 shows this.

The language model tuned to provision of vehicle information may add the response based on the vehicle information to the primary response.

The response based on the vehicle information may be information on a place if there is the place related to the vehicle type within the destination or the target area. In the case of Table 3, since a type of vehicle that the user boards is an electric vehicle, the information is whether a parking lot of Aqua Planet Jeju has an electric vehicle charging station, and the type and number of electric vehicle chargers.

Referring to Table 3, the secondary response is “Aqua Planet Jeju is an aquarium operated by Hanhwa Group located at 95 Seopjikoji-ro, Seongsan-eup, Seogwipo-si, Jeju-do. This is the only aquarium in Jeju, and is the largest in Korea, and is 11 times larger than the Aqua Planet located at 63 Building, Seoul. The aquarium has 48,000 animals belonging to 500 different species. The aquarium positions itself as ‘amusement theme park’ for education, culture, and entertainment. The parking lot is equipped with a total of seven electric vehicle chargers including two electric vehicle chargers for rapid charging and five electric vehicle chargers for slow charging.”

When comparing the secondary response to the primary response, the response based on the vehicle information, for example, “The parking lot is equipped with a total of seven electric vehicle chargers including two electric vehicle chargers for rapid charging and five electric vehicle chargers for slow charging.” was added.

The response system adjusts the secondary response using the language model tuned to adjustment of response length or fact verification.

The adjustment of the response length may be comparing the time remaining until another guidance with the length of the secondary response, and decreasing the length of the secondary response if the length of the secondary response exceeds the time remaining until another guidance. The other guidance may include route guidance.

In the case of Table 3, a length of time it takes for the response system to provide the secondary response by voice exceeds a time remaining until route guidance. The language model tuned to the adjustment of the response length adjusts the secondary response by reducing the length of the secondary response.

Referring to Table 3, the adjusted secondary response is “Aqua Planet Jeju is an aquarium operated by Hanhwa Group located at 95 Seopjikoji-ro, Seongsan-eup, Seogwipo-si, Jeju-do. This is the only aquarium in Jeju, and is the largest in Korea, and is 11 times larger than the Aqua Planet located at 63 Building, Seoul.”<Break for route guidance>“The aquarium has 48,000 animals belonging to 500 different species. The aquarium positions itself as ‘amusement theme park’ for education, culture, and entertainment.” (m) of Table 3 shows this.

If comparing the adjusted secondary response to the existing secondary response, a difference is that there is a pause in the middle for route guidance. The length of each response before and after the pause, wherein each response is included in the adjusted secondary response, is shorter than the length of the existing secondary response.

The response system outputs the adjusted secondary response. (m) of Table 3 is provided to the user. In addition, (m) of Table 3 may be converted into a format that may be provided as an AVNT (Audio, Video, Navigation, Telecommunication) scenario.

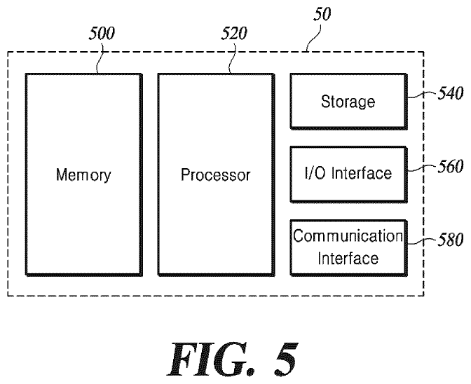

FIG. 5 shows an example computing device that may be used to implement the method or device according to examples of the present disclosure.

A computing device 50 may include some or all of a memory 500, a processor 520, a storage 540, an input and output (I/O) interface 560, and a communication interface 580. The computing device 50 may be a stationary computing device such as a desktop computer, a server, or an AI accelerator, or a mobile computing device such as a laptop computer or a smart phone.

The memory 500 may store a program that allows the processor 520 to perform methods or operations according to various examples of the present disclosure. For example, the program may include a plurality of instructions that are executable by the processor 520. The method illustrated in FIG. 1, FIG. 3 and FIG. 4 may thus be performed by the plurality of instructions being executed by the processor 520.

The memory 500 may be a single memory or a plurality of memories. In this case, information used to perform methods or operations according to various examples of the present disclosure may be stored in the single memory or divided and stored in the plurality of memories. If the memory 500 is configured of the plurality of memories, the plurality of memories may be physically separated.

The memory 500 may include at least one of a volatile memory and a non-volatile memory. The volatile memory includes a static random access memory (SRAM), a dynamic random access memory (DRAM), or the like, and the non-volatile memory includes a flash memory.

The processor 520 may include at least one core capable of executing at least one instruction. The processor 520 may execute instructions stored in the memory 500. The processor 520 may be a single processor or a plurality of processors.

The storage 540 maintains stored data even if power supplied to the computing device 50 is cut off. For example, the storage 540 may include a non-volatile memory or may include a storage medium such as a magnetic tape, optical disc, or magnetic disk.

A program stored in the storage 540 may be loaded into the memory 500 before being executed by the processor 520. The storage 540 may store files created in a program language, and a program created from a file by a compiler or the like may be loaded into the memory 500. The storage 540 may store data to be processed by the processor 520 and/or data processed by the processor 520.

The I/O interface 560 may provide an interface with an input device such as a keyboard or mouse, and/or an output device such as a display device or printer. A user may trigger execution of a program in the processor 520 through the input device and/or check a processing result of the processor 520 through the output device.

The communication interface 580 may provide access to an external network. For example, the computing device 50 may communicate with another device via the communication interface 580.

The present disclosure is to provide an appropriate response to a voice of a user using a generative language model. More specifically, a main object of the present disclosure is to provide a travel guide that enhances user experience, including not only destination route guidance but also recommendations of nearby attractions, by combining a generative language model with a voice recognition service and a navigation service.

The problems to be solved by the present disclosure are not limited to the above-mentioned problems, and other problems not mentioned will be clearly understood by those skilled in the art from the description below.

An example of the present disclosure provides a computer implementation method of providing a response to a voice of a user using a language model, the method comprising: acquiring a primary response to a current utterance by applying a first language model to the current utterance and a previous conversation; acquiring a secondary response by applying a language model tuned to provision of position information and weather information to the primary response, and applying a language model tuned to provision of vehicle information to the primary response; adjusting the secondary response by applying a language model tuned to adjustment of a response length or fact verification to the secondary response; and providing the adjusted secondary response, wherein the current utterance or the previous conversation is related to a request for information of a destination or target area.

Another example of the present disclosure provides an apparatus for providing a response to a voice of a user using a language model, the apparatus comprising: a memory configured to store one or more instructions; and at least one processor, wherein the at least one processor executes the one or more instructions to acquire a primary response to a current utterance by applying a first language model to the current utterance and a previous conversation; acquire a secondary response by applying a language model tuned to provision of position information and weather information to the primary response, and applying a language model tuned to provision of vehicle information to the primary response; adjust the secondary response by applying a language model tuned to adjustment of a response length or fact verification to the secondary response; and provide the adjusted secondary response, wherein the current utterance or the previous conversation is related to a request for information of a destination or target area.

According to an example of the present disclosure, it is possible to provide a travel guide that enhances user experience, including not only destination route guidance but also recommendations of nearby attractions, by combining a generative language model with a voice recognition service and a navigation service.

According to an example of the present disclosure, it is possible to provide a response that matches an utterance intention of the user and an entire conversation context by inputting not only a current utterance of the user but also a previous conversation to the generative language model.

According to an example of the present disclosure, it is possible to provide a response that matches an utterance intention of the user and an entire conversation context by providing prompts to the generative language model step-by-step.

According to an example of the present disclosure, it is possible to provide a travel guide that enhances user experience by providing the generated primary response through operations, such as addition of vehicle information, adjustment of the length, and verification of facts.

The advantageous effects of the present disclosure are not limited to those described above; other advantageous effects of the present disclosure not mentioned above may be understood clearly by those skilled in the art from the descriptions given below.

At least some of the components described in the examples of the present disclosure may be implemented by a hardware element including at least one of a digital signal processor (DSP), a processor, a controller, an application-specific IC (ASIC), a programmable logic device (FPGA, or the like), and other electronic devices, or a combination thereof. Additionally, at least some of the functions or processes described in the examples may be implemented as software, and the software may be stored in a recording medium. At least some of the components, functions, and processes described in examples of the present disclosure may be implemented through a combination of hardware and software.

Methods according to examples of the disclosure may be written as programs executable on a computer and may also be implemented on various recording mediums, such as magnetic storage medium, optical readout medium, digital storage medium.

Implementations of the various techniques described herein may be implemented as digital electronic circuitry, or as computer hardware, firmware, software, or combinations thereof. Implementations may be implemented as computer program products, i.e., computer programs tangibly embodied in an information carrier, e.g., a machine-readable storage device (computer-readable medium) or a radio signal, for processing by a data processing device, e.g., a programmable processor, a computer, or the operation of a plurality of computers, or for controlling the operation of a plurality of computers.

Although this specification includes details of a number of specific implementations, they should not be understood as limiting any disclosure or the scope of what may be claimed, but rather as a description of features that may be peculiar to a particular example of the disclosure. Certain features described herein in the context of individual examples may be implemented in combination in a single example. Conversely, various features described in the context of a single example may also be implemented individually or in any suitable sub-combination in a plurality of examples. Further, while features may operate in a particular combination and may be initially described as claimed as such, one or more features of a claimed combination may be excluded from that combination in some instances, and the claimed combination may be changed to a sub-combination or variation of a sub-combination.

The examples of the disclosure described herein and in the drawings are shown by way of illustration only and are not intended to limit the scope of the disclosure. That other modifications based on the technical ideas of the present disclosure may be practiced in addition to the examples disclosed herein will be apparent to one of ordinary skill in the art to which the present disclosure belongs.

The scope of protection of the examples herein shall be construed in accordance with the claims below, and all technical ideas within the scope thereof shall be construed to be included within the scope of the claims herein.

What is claimed is:

1. A method for controlling operation of a vehicle, the method comprising:
acquiring, based on a first machine learning model associated with a current input and a previous stream of inputs, a primary response to the current input;
acquiring, based on applications of a second machine learning model and a third machine learning model to the primary response, a secondary response, wherein the second machine learning model is tuned to provision of position information and weather information associated with the vehicle, and wherein the third machine learning model is tuned to provision of vehicle information;
adjusting, based on a fourth machine learning model, the secondary response, wherein the fourth machine learning model is tuned to a length adjustment of the secondary response or tuned to verification of information associated with the secondary response;
outputting the adjusted secondary response, wherein the current input or the previous steam of inputs is related to a request for information of a destination area or a target area for the vehicle; and
controlling, based on the adjusted secondary response, operation of the vehicle.

2. The method of claim 1, wherein the acquiring the primary response comprises:
inputting a first input for semantic inference to the first machine learning model;
inputting a second input for function classification to the first machine learning model;
inputting a third input for a query creation to the first machine learning model;
searching, based on the query generated by the first machine learning model, for a document in a database; and
inputting, based on content of the document, a fourth input for generation of the primary response to the first machine learning model.

3. The method of claim 2, wherein the acquiring the secondary response comprises:
acquiring, based on positions of the destination and the target area, an estimated travel time from the destination to the target area; and
adding the estimated travel time to the primary response.

4. The method of claim 3, wherein the acquiring the secondary response comprises:
acquiring weather information of the destination and weather information of the target area; and
adding the weather information of the destination and the weather information of the target area to the primary response.

5. The method of claim 2, wherein the acquiring the secondary response comprises:
acquiring information on a vehicle type of the vehicle; and
adding, based on a place being related to the vehicle type within the destination and the target area, information on the place to the primary response; and
adding, based on owners of the same vehicle type having visited the destination and the target area, information on a visit frequency to the primary response.

6. The method of claim 1, wherein the adjusting the secondary response comprises:
comparing a time remaining until another guidance with a length of the secondary response; and
decreasing, based on the length of the secondary response exceeding the time remaining until the other guidance, the length of the secondary response.

7. The method of claim 1, wherein the adjusting the secondary response comprises:
increasing or decreasing a length of the secondary response to meet a request from a user of the vehicle, wherein the request is received within the current input and the previous streams of inputs.

8. The method of claim 1, wherein the adjusting the secondary response comprises:
verifying, based on a database used for the primary response and the secondary response, the secondary response; and
determining whether a prohibited word is included in the secondary response.

9. An apparatus for controlling operation of a vehicle, the apparatus comprising:
a memory configured to store one or more instructions; and
at least one processor configured to execute the one or more instructions to:
acquire, based on a first machine learning model associated with a current input and a previous stream of inputs, a primary response to the current input;
acquire, based on applications of a second machine learning model and a third machine learning model to the primary response, a secondary response, wherein the second machine learning model is tuned to provision of position information and weather information associated with the vehicle, and wherein the third machine learning model is tuned to provision of vehicle information;
adjust, based on a fourth machine learning model, the secondary response, wherein the fourth machine learning model is tuned to a length adjustment of the secondary response or tuned to verification of information associated with the secondary response;
output the adjusted secondary response, wherein the current input or the previous stream of inputs is related to a request for information of a destination area or a target area for the vehicle; and
control, based on the adjusted secondary response, operation of the vehicle.

10. The apparatus of claim 9, wherein the at least one processor is further configured to execute the one or more instructions to:
input a first input for semantic inference to the first machine learning model;
input a second input for function classification to the first machine learning model;
input a third input for query creation to the first machine learning model;
search, based on a query generated by the first machine learning model, for a document in a database; and
input, based on content of the document, a fourth input for generation of the primary response to the first machine learning model.

11. The apparatus of claim 10, wherein the at least one processor is further configured to execute the one or more instructions to:
acquire, based on positions of the destination and the target area, an estimated travel time from the destination to the target area; and
add the estimated travel time to the primary response.

12. The apparatus of claim 11, wherein the at least one processor is further configured to execute the one or more instructions to:
acquire weather information of the destination and weather information of the target area; and
add the weather information of the destination and the weather information of the target area to the primary response.

13. The apparatus of claim 10, wherein the at least one processor is further configured to execute the one or more instructions to:
acquire information on a vehicle type of the vehicle; and
add, based on a place being related to the vehicle type within the destination and the target area, information on the place to the primary response; and
add, based on owners of a same vehicle type having visited the destination and the target area, information on a visit frequency to the primary response.

14. The apparatus of claim 9, wherein the at least one processor is further configured to execute the one or more instructions to:
comparing a time remaining until another guidance with a length of the secondary response; and
decrease, based on the length of the secondary response exceeding the time remaining until the other guidance, the length of the secondary response.

15. The apparatus of claim 9, wherein the at least one processor is further configured to execute the one or more instructions to:
increase or decrease a length of the secondary response to satisfy a request from a user of the vehicle, wherein the request is received within the current input and the previous stream of inputs.

16. The apparatus of claim 9, wherein the at least one processor is further configured to execute the one or more instructions to:
verify, based on a database used for the primary response and the secondary response, the secondary response; and
determine whether a prohibited word is included in the secondary response.
